(19) United States
(12) Patent Application Publication
(10) Pub. No.: US 2016/0212086 A1
(43) Pub. Date: Jul. 21, 2016

(54) MESSAGE PROCESSING, FORWARDING AND FILTERING BASED ON ATTRIBUTE VALUES

(71) Applicant: Synchronoss Technologies, Inc., Bridgewater, NJ (US)

(72) Inventors: Dennis P. Mathew, Allentown, PA (US); Janet F. Sala, Belvidere, NJ (US); Anbarasu Chinnaswamy, Basking Ridge, NJ (US)

(73) Assignee: Synchronoss Technologies, Inc., Bridgewater, NJ (US)

(21) Appl. No.: 15/000,932

(22) Filed: Jan. 19, 2016

Related U.S. Application Data
(60) Provisional application No. 62/105,581, filed on Jan. 20, 2015.
(60) Provisional application No. 62/105,590, filed on Jan. 20, 2015.
(60) Provisional application No. 62/105,593, filed on Jan. 20, 2015.

(51) Int. Cl. H04L 12/58

(52) U.S. Cl. CPC H04L 51/26; H04L 51/12; H04L 51/14

(57) ABSTRACT

Message processing, forwarding and filtering are able to be implemented based on attribute-values extracted from a message. By utilizing attributes within the body of the message instead of header information, control of the messages is more dynamic.

### CROSS-REFERENCE TO RELATED APPLICATION(S)

This application claims priority under 35 U.S.C. §119(e) of the U.S. Provisional Patent Application Ser. No. 62/105,581, filed Jan. 20, 2015 and titled, “PRIORITY MESSAGE PROCESSING BASED ON ATTRIBUTE VALUES,” the U.S. Provisional Patent Application Ser. No. 62/105,590, filed Jan. 20, 2015 and titled, “DISCRETIONARY MESSAGE FORWARDING BASED ON ATTRIBUTE VALUES,” and the U.S. Provisional Patent Application Ser. No. 62/105,593, filed Jan. 20, 2015 and titled, “FILTERING TRANSACTIONAL TRAFFIC BASED ON ATTRIBUTE VALUES” which are all also hereby incorporated by reference in their entireties for all purposes.

### FIELD OF THE INVENTION

The present invention relates to the field of message processing. More specifically, the present invention relates to message processing, forwarding and filtering.

### BACKGROUND OF THE INVENTION

Typically messages are processed based on schemes such as FIFO, LIFO, timestamp or meta-information such as addressee, or priority ranking (e.g., high, low). That information is part of the message header and part of the interface agreement not content of the message itself.

### SUMMARY OF THE INVENTION

Message processing, forwarding and filtering are able to be implemented based on attribute-values extracted from a message. By utilizing attributes within the body of the message instead of header information, control of the messages is more dynamic.

### BRIEF DESCRIPTION OF THE DRAWINGS

FIG. 1 illustrates a flowchart of a method of implementing message processing according to some embodiments.

FIG. 2 illustrates a flowchart of a method of implementing message forwarding according to some embodiments.

FIG. 3 illustrates a flowchart of a method of implementing message filtering according to some embodiments.

FIG. 4 illustrates a network of devices implementing the processing, forwarding and filtering methods according to some embodiments.

FIG. 5 illustrates a block diagram of an exemplary computing device configured to implement the processing, forwarding and filtering methods according to some embodiments.

### DETAILED DESCRIPTION OF THE PREFERRED EMBODIMENT

Messages or packets include header information (e.g., version, length, priority, address information) and body information (e.g., the content of the message including attributes). Described herein is a method to process, forward and filter messages based on attribute values within the body of the message.

### Message Processing

When a transaction message is received, the message is parsed, and key configured attribute values are extracted and persisted. The priority for processing the message is able to be based on any configured attribute. Some examples of attributes that can be used to control priority are Stock Keeping Unit (SKU) number or account number.

The message processing method permits the prioritization of messages based on transaction specific information instead of basic schemes. The message processing method enables the use of information in the body of the message to determine the priority of the processing.

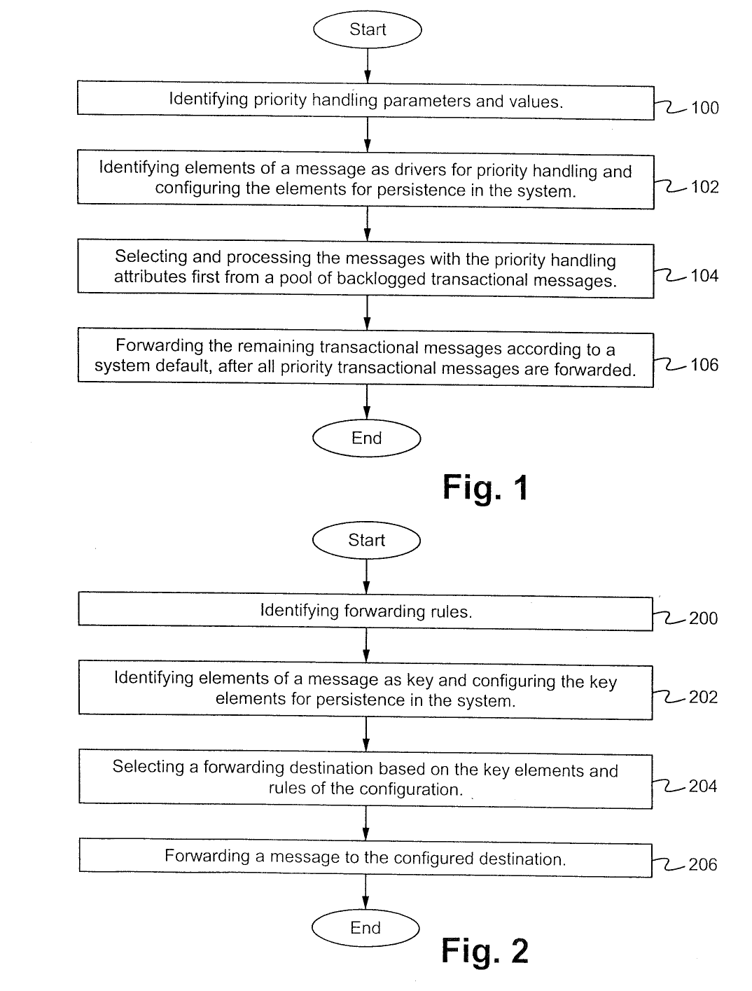

FIG. 1 illustrates a flowchart of a method of implementing message processing according to some embodiments. In the step 100, priority handling parameters and values are identified. The priority handling parameters and values are able to be identified in any manner such as by a user inputting the parameters and values in a data structure (e.g., look up table) for comparison, or automatically determining the parameters based on detection of a keyword or data in a specific location (e.g., in a specific position in a message). In the step 102, elements of a message are identified as drivers for priority handling and configured for persistence in the system. As a message is received, the key elements are persisted (e.g., they are written in a data structure on a hard drive or other non-volatile storage). Key elements are able to be determined in any manner such as keyword detection (e.g., comparing text in a message with a data structure storing key elements to determine any matches). In the step 104, the messages with the priority handling attributes are selected and processed first from a pool of backlogged transactional messages. For example, each message is analyzed, and it is determined if the message contains one or more of the priority handling attributes. Furthering the example, one or more specific elements of the body of the message are compared with the data structure to determine if the message contains one or more of the priority handling attributes. Priority selection is constant and is the first attribute for forwarding. After all priority transactional messages are forwarded, the remaining transactional messages are forwarded according to a system default (e.g., FIFO), in the step 106. In some embodiments, fewer or additional steps are implemented. In some embodiments, the order of the steps is modified.

### Message Forwarding

When a transaction message is received, it is parsed and key configured attribute-values are extracted and persisted. The forwarding method can then forward messages based on any configured attribute.

The forwarding method permits the transmittal of message transactions based on transaction-specific information. Typically messages are transmitted based on schemes such as a timestamp or meta information such as addressee or priority. That information is part of the message header and part of the interface agreement, not content of the message itself.

FIG. 2 illustrates a flowchart of a method of implementing message forwarding according to some embodiments. In the step 200, forwarding rules are identified. The forwarding rules are able to be identified in any manner such as by retrieving rules from a data structure (e.g., look up table), or automatically determining the rules. In some embodiments, users select or specify the forwarding rules. In the step 202, elements of a message are identified as key, and the elements are configured for persistence in the system. As a message is received, the key elements are persisted. In the step 204, a forwarding destination is selected based on the key elements and rules of the configuration. In the step 206, a message is forwarded to the configured destination. In some embodiments, fewer or additional steps are implemented. In some embodiments, the order of the steps is modified.

### Message Filtering

When a transaction message is received, it is parsed and key configured attribute values are extracted and persisted. The filtering method can apply filters to messages based on any configured attribute. Any element of the message can be identified and used for filtering. The filtering method permits the filtering of messages based on transaction-specific information.

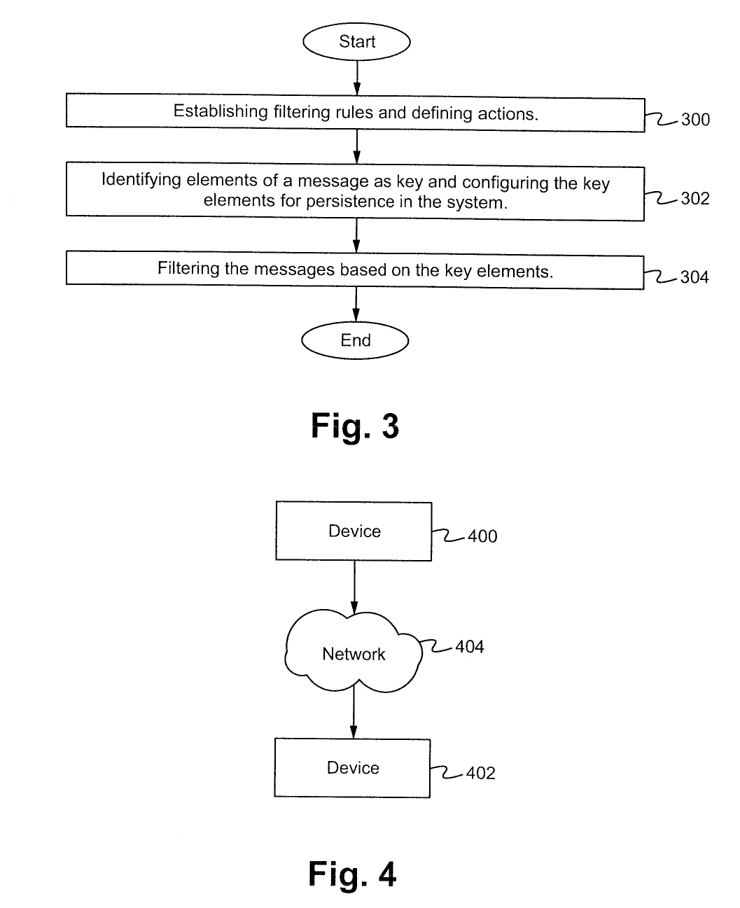

FIG. 3 illustrates a flowchart of a method of implementing message filtering according to some embodiments. In the step 300, filtering rules are established and actions are defined. In some embodiments, the filtering rules and corresponding actions are stored in a database or other data structure (e.g., if a rule is detected, then a specific action is taken). In the step 302, elements of a message are identified as key and configure for persistence in the system. As a message is received, the key elements are persisted. In the step 304, the messages are filtered based on the key elements. In some embodiments, fewer or additional steps are implemented. In some embodiments, the order of the steps is modified.

In some embodiments, the processing, forwarding and filtering methods are able to be implemented together. For example, priority handling parameters and values, forwarding rules and/or filtering rules and actions are identified, established and/or defined. Elements of a message are identified as drivers for priority handling or as key and are configured for persistence in the system. As a message is received, the key elements are persisted. For message processing, the messages with the priority handling attributes are selected and processed first from a pool of backlogged transactional messages. Priority selection is constant and is the first attribute for forwarding. After all priority transactional messages are forwarded, the remaining transactional messages are forwarded according to a system default. For message forwarding, a forwarding destination is selected based on the key elements and rules of the configuration, and a message is forwarded to the configured destination. For message filtering, the messages are filtered based on the key elements. In some embodiments, fewer or additional steps are implemented. In some embodiments, the order of the steps is modified.

FIG. 4 illustrates a network of devices implementing the processing, forwarding and filtering methods according to some embodiments. A first device 400 (e.g., a computer, smart phone, tablet, laptop) and a second device 402 (e.g., a computer, smart phone, tablet, laptop) communicate through a network 404 or directly. The first device 400 sends a message, and the message is processed, forward, and/or filtered using the methods described herein. The network 404 is able to be any network such as a wireless network, cellular network, the Internet, or a combination thereof. In some embodiments, fewer or additional devices are utilized.

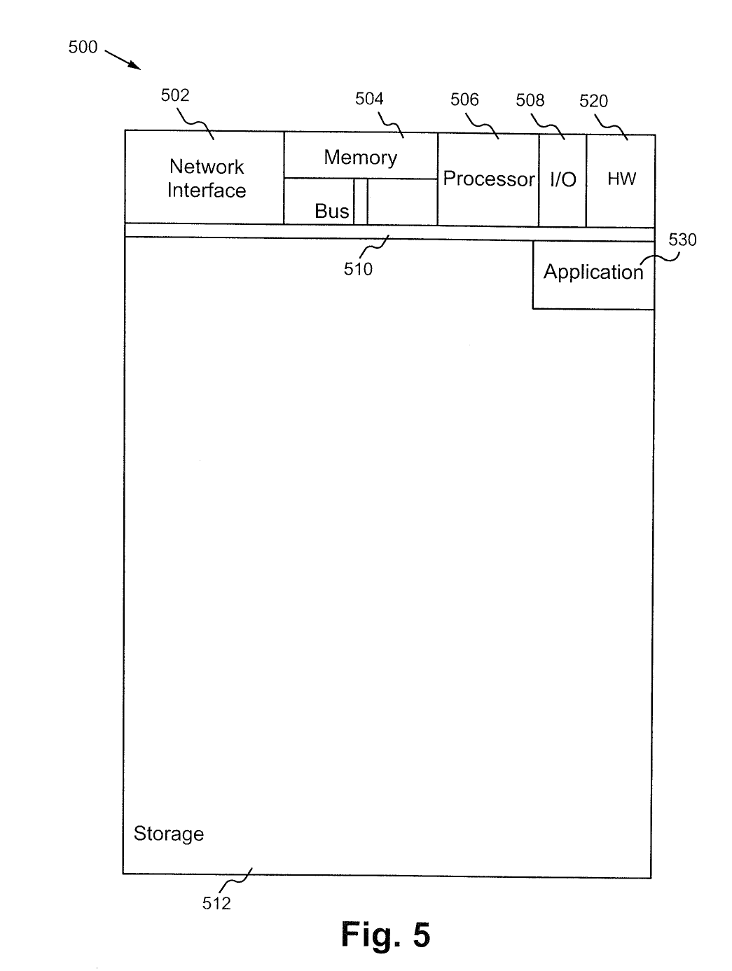

FIG. 5 illustrates a block diagram of an exemplary computing device configured to implement the processing, forwarding and filtering methods according to some embodiments. The computing device 500 is able to be used to acquire, store, compute, process, communicate and/or display information. For example, a computing device 500 is a user/client device, a cloud device or any other device. In general, a hardware structure suitable for implementing the computing device 500 includes a network interface 502, a memory 504, a processor 506, I/O device(s) 508, a bus 510 and a storage device 512. The choice of processor is not critical as long as a suitable processor with sufficient speed is chosen. The memory 504 is able to be any conventional computer memory known in the art. The storage device 512 is able to include a hard drive, CDROM, CDRW, DVD, DVDRW, Blu-Ray®, flash memory card or any other storage device. The computing device 500 is able to include one or more network interfaces 502. An example of a network interface includes a network card connected to an Ethernet or other type of LAN. The I/O device(s) 508 are able to include one or more of the following: keyboard, mouse, monitor, display, printer, modem, touchscreen, button interface and other devices. In some embodiments, the hardware structure includes multiple processors and other hardware to perform parallel processing. Processing, forwarding and filtering application(s) 530 used to perform the processing, forwarding and filtering methods are likely to be stored in the storage device 512 and memory 504 and processed as applications are typically processed. More or fewer components shown in FIG. 5 are able to be included in the computing device 500. In some embodiments, processing, forwarding and filtering hardware 520 is included. Although the computing device 500 in FIG. 5 includes applications 530 and hardware 520 for implementing the processing, forwarding and filtering methods, the processing, forwarding and filtering methods are able to be implemented on a computing device in hardware, firmware, software or any combination thereof For example, in some embodiments, the processing, forwarding and filtering applications 530 are programmed in a memory and executed using a processor. In another example, in some embodiments, the processing, forwarding and filtering hardware 520 is programmed hardware logic including gates specifically designed to implement the method.

In some embodiments, the processing, forwarding and filtering application(s) 530 include several applications and/or modules. In some embodiments, modules include one or more sub-modules as well.

Examples of suitable computing devices include a personal computer, a laptop computer, a computer workstation, a server, a mainframe computer, a handheld computer, a personal digital assistant, a cellular/mobile telephone (e.g. an iPhone®), a smart appliance, a tablet computer (e.g. an iPad®), a smart watch, or any other suitable computing device.

To utilize the processing, forwarding and filtering methods, key elements are selected by a user or automatically determined by a device, and those key elements are used to process, forward and filter messages.

In operation, the processing, forwarding and filtering methods solve the problem of how to prioritize transactions dynamically based on the content of the message rather than using predefined processing cues in the message header. This makes interface agreements much more flexible as prioritization can be controlled on the receiving end rather than on the sending side. The methods solve the problem of dynamically forwarding transactional messages to the system or service specifically and dynamically configured to handle transactions based on values in the body of the transactional message. Changing priority based on dynamic business need is an important problem to be solved for managing the customer experience.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method programmed in a non-transitory memory of a device comprising:
a. identifying parameters and rules;
b. identifying elements of a message as key and configuring the key elements for persistence in the device;
c. performing processing, forwarding, filtering of messages, or a combination thereof based on the key elements of the message.

2. The method of claim 1 wherein identifying parameters and rules includes identifying priority handling parameters.

3. The method of claim 1 wherein identifying parameters and rules includes identifying forwarding rules.

4. The method of claim 1 wherein identifying parameters and rules includes establishing filtering rules and defining corresponding actions.

5. The method of claim 1 further comprising selecting and processing the messages with the priority handling attributes first, from a pool of backlogged transactional messages.

6. The method of claim 5 wherein after all priority transactional messages are forwarded, the remaining transactional messages are forwarded according to a system default.

7. The method of claim 1 further comprising selecting a forwarding destination based on the key elements and rules of the configuration, and forwarding the message to the configured destination.

8. An apparatus comprising:
a. a non-transitory memory for storing an application, the application for automatically:
i. identifying parameters and rules;
ii. identifying elements of a message as key and configuring the key elements for persistence in the device;
iii. performing processing, forwarding, filtering of messages, or a combination thereof based on the key elements of the message; and
b. a processing component coupled to the memory, the processing component configured for processing the application.

9. The apparatus of claim 8 wherein identifying parameters and rules includes identifying priority handling parameters.

10. The apparatus of claim 8 wherein identifying parameters and rules includes identifying forwarding rules.

11. The apparatus of claim 8 wherein identifying parameters and rules includes establishing filtering rules and defining corresponding actions.

12. The apparatus of claim 8 wherein the application is further for selecting and processing the messages with the priority handling attributes first, from a pool of backlogged transactional messages.

13. The apparatus of claim 12 wherein after all priority transactional messages are forwarded, the remaining transactional messages are forwarded according to a system default.

14. The apparatus of claim 8 wherein the application is further for selecting a forwarding destination based on the key elements and rules of the configuration, and forwarding the message to the configured destination.

15. A system comprising:
a. a parameter module configured for identifying parameters and rules;
b. an element module configured for identifying elements of a message as key and configuring the key elements for persistence in the device;
c. a message module configured for performing processing, forwarding, filtering of messages, or a combination thereof based on the key elements of the message.

16. The system of claim 15 wherein identifying parameters and rules includes identifying priority handling parameters.

17. The system of claim 15 wherein identifying parameters and rules includes identifying forwarding rules.

18. The system of claim 15 wherein identifying parameters and rules includes establishing filtering rules and defining corresponding actions.

19. The system of claim 15 further comprising a selection module configured for selecting and processing the messages with the priority handling attributes first, from a pool of backlogged transactional messages.

20. The system of claim 19 wherein after all priority transactional messages are forwarded, the remaining transactional messages are forwarded according to a system default.

21. The system of claim 19 further comprising a forwarding module configured for selecting a forwarding destination based on the key elements and rules of the configuration, and forwarding the message to the configured destination.
